(19) United States
(12) Patent Application Publication
(10) Pub. No.: US 2008/0152135 A1
(43) Pub. Date: Jun. 26, 2008

(54) Information processing apparatus

(75) Inventors: Yoshinori Nishimoto, Tokyo (JP); Noriyuki Hirayama, Tokyo (JP); Kazuyo Kuroda, Tokyo (JP); Tetsuo Hatakeyama, Tokyo (JP); Koji Kanazawa, Tokyo (JP)

Correspondence Address: BLAKELY SOKOLOFF TAYLOR & ZAFMAN, 1279 OAKMEAD PARKWAY, SUNNYVALE, CA, 94085-4040, US

(73) Assignee: Kabushiki Kaisha Toshiba

(21) Appl. No.: 11/881,497

(22) Filed: Jul. 26, 2007

(30) Foreign Application Priority Data
Dec. 22, 2006 (JP) P2006-346286

(51) Int. Cl. H04N 7/167

(52) U.S. Cl. 380/200

(57) ABSTRACT

According to one embodiment, an information processing apparatus includes a plurality of data encryption devices obtaining and encrypting contents data, a plurality of data decryption devices provided corresponding to the data encryption devices respectively, each of the data decryption devices obtaining the contents data via a user access bus from corresponding one of the data encryption devices and decrypting the contents data, and a data storage device storing the contents data encrypted by the data decryption devices, in which key data for decrypting the contents data stored in the data storage device is stored in one of the data encryption devices.

### CROSS-REFERENCE TO RELATED APPLICATIONS

This application is based upon and claims the benefit of priority from Japanese Patent Application No. 2006-346286, filed Dec. 22, 2006, the entire contents of which are incorporated herein by reference.

### BACKGROUND

1. Field

One embodiment of the invention relates to an information processing apparatus having a function to obtain contents data of a digital broadcast or the like.

2. Description of the Related Art

There are known digital broadcast receiving apparatuses having a plurality of receiving systems each constituted of a tuner unit and a demodulating unit for simultaneously receiving digital broadcasts transmitted via a plurality of channels (for example, refer to Japanese Patent Application Publication (KOKAI) No. 2004-336518).

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing a system configuration of an information processing apparatus according to an embodiment of the invention;

FIG. 2 is an exemplary Master/Slave mode identification transition diagram for copyright protection LSIs in the embodiment; and

FIG. 3 is an exemplary Master/Slave mode decision flowchart for the copyright protection LSIs in the embodiment.

### DETAILED DESCRIPTION

Various embodiments according to the invention will be described hereinafter with reference to the accompanying drawings. In general, according to one embodiment of the invention, an information processing apparatus includes a plurality of data encryption devices obtaining and encrypting contents data, a plurality of data decryption devices provided corresponding to the data encryption devices respectively, each of the data decryption devices obtaining the contents data via a user access bus from corresponding one of the data encryption devices and decrypting the contents data, and a data storage device storing the contents data encrypted by the data decryption devices, in which key data for decrypting the contents data stored in the data storage device is stored in one of the data encryption devices.

Hereinafter, preferred embodiments of the invention will be described in detail with reference to the drawings.

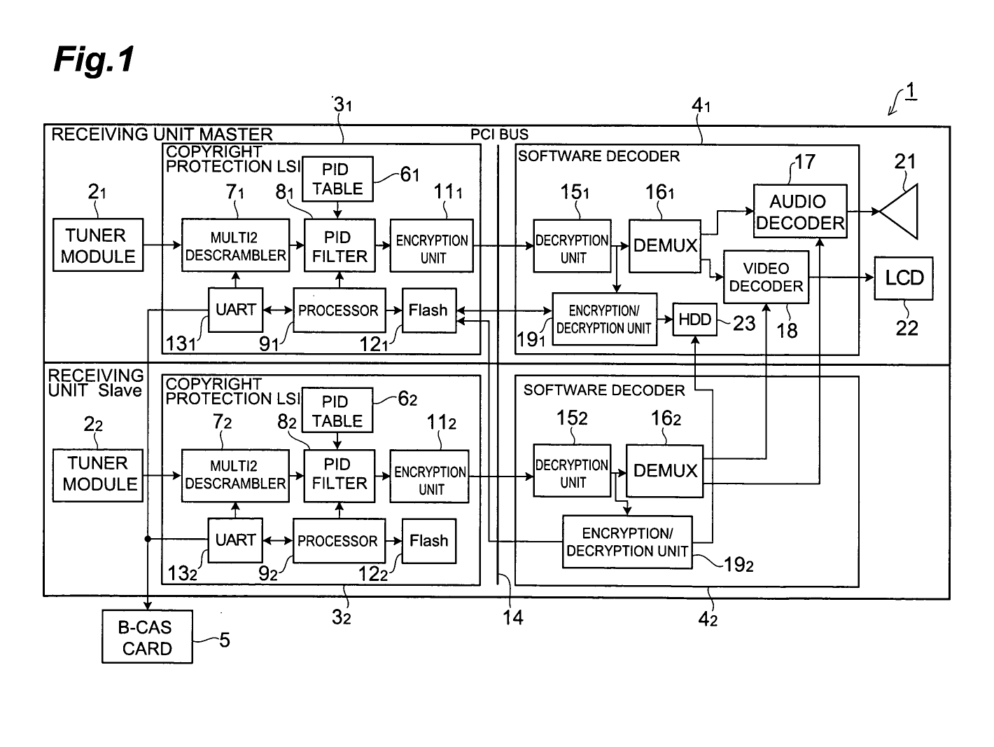

As shown in FIG. 1, an information processing apparatus 1 is a personal computer including a receiving system Master and a receiving system Slave. The receiving system Master has a tuner module 2₁ for receiving contents data of a digital broadcast, a copyright protection LSI (data encryption device) 3₁, and a software decoder (data decryption device) 4₁ for executing processing of reproducing, recording, and so forth on received contents data. Similarly, the receiving system Slave has a tuner module 2₂, a copyright protection LSI (data encryption device) 3₂, and a software decoder (data decryption device) 4₂. Note that a B-CAS (Broadcasting satellite-Conditional Access Systems) card 5 is used in common by the copyright protection LSIs 3₁, 3₂.

The tuner module 2₁ and the copyright protection LSI 3₁ are constructed in one tuner card, and the tuner module 2₂ and the copyright protection LSI 3₂ are constructed in another tuner card. As the tuner cards, for example, mini PCI cards are used, which can be inserted into a mini PCI slot of the information processing apparatus 1. When the tuner cards are fitted in the information processing apparatus 1, the copyright protection LSI 3₁ (3₂) and the software decoder 4₁ (4₂) are connected via the PCI bus (user access bus) 14.

The copyright protection LSI 3₁ has a PID table 6₁ indicating a TS packet having a packet identifier (PID) being a fixed value, a MULTI2 descrambler 7₁, a PID filter 8₁ passing only a TS packet having a PID specified by a higher application, a processor 9₁, an encryption unit 11₁ which locally encrypt contents data, a Flash 12₁, and a UART 13₁ which controls the B-CAS card 5. Similarly, the copyright protection LSI 3₂ has a PID table 6₂, a MULTI2 descrambler 7₂, a PID filter 8₂ a processor 9₂, an encryption unit 11₂, a Flash 12₂ and a UART 13₂.

The software decider 4₁ has a decryption unit 15₁ which decrypts contents data obtained via the PCI bus 14 from the encryption unit 11₁, a demux 16₁ which separates decrypted contents data into audio data and video data, an audio decoder 17 which decodes the separated audio data, a video decoder 18 which decodes the separated video data, and an encryption/decryption unit 19₁.

The software decoder 4₂ has a decryption unit 15₂ which decrypts contents data obtained via the PCI bus 14 from the encryption unit 11₂, a demux 16₂ which separates decrypted contents data into audio data and video data, and an encryption/decryption unit 19₂. The audio data separated by the demux 16₂ is outputted to the audio decoder 17, and the video data separated by the demux 16₂ is outputted to the video decoder 18.

The audio data decoded by the audio decoder 17 is outputted to a speaker 21 as an audio output device, and the video data decoded by the video decoder 18 is outputted to an LCD (Liquid Crystal Display) 22 as a video output device. Thus, the contents data is reproduced.

The encryption/decryption unit 19₁ (19₂) encrypts again the contents data decrypted by the decryption unit 15₁ (15₂) and stores the data in an HDD 23. Thus, the contents data is recorded. Further, the encryption/decryption unit 19₁ (19₂) decrypts the contents data stored in the HDD 23 so as to reproduce the recorded contents data.

Key data used for encryption and decryption of contents data by the encryption/decryption unit 19₁ is generated for every contents data by the processor 9₁ of the copyright protection LSI 3₁ on the receiving system Master side, and stored in the Flash 12₁ of the copyright protection LSI 3₁ on the receiving system Master side. Further, key data used for encryption and decryption of contents data by the encryption/decryption unit 19₂ is generated for every contents data by the processor 9₂ of the copyright protection LSI 3₂ on the receiving system Slave side, but stored in the Flash 12₁ of the copyright protection LSI 3₁ on the receiving system Master side. In other words, the encryption/decryption units 19₁, 19₂ obtain the key data from the Flash 12₁ of the copyright protection LSI 3₁ on the receiving system Master side and decrypt the contents data stored in the HDD 23.

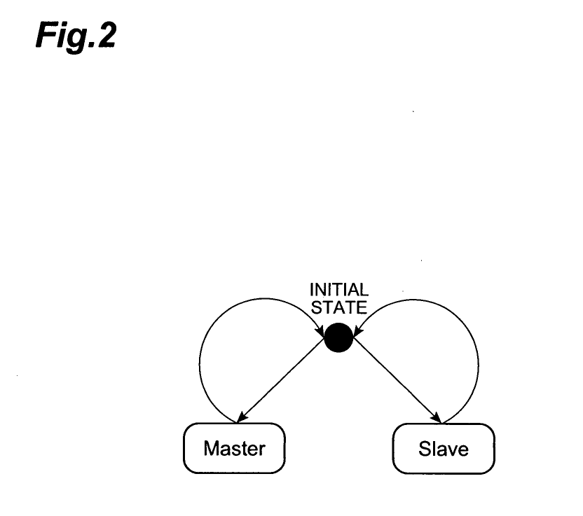

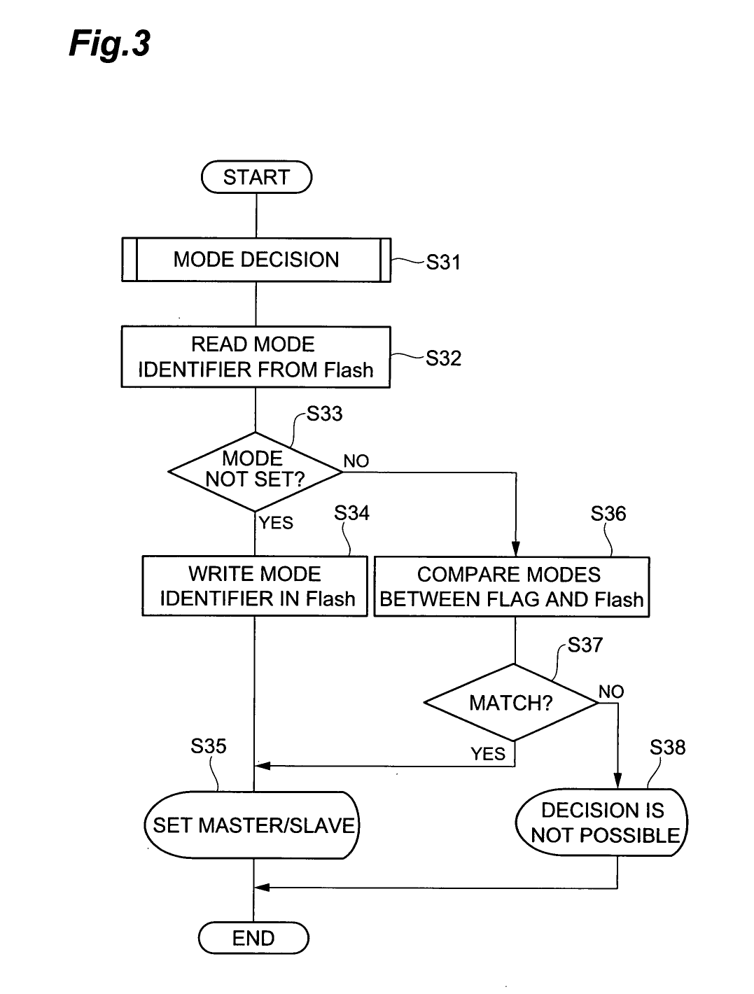

Next, setting of a Master/Slave mode to the copyright protection LSIs 3₁, 3₂ will be explained. FIG. 2 is a Master/Slave mode identification transition diagram for the copyright protection LSIs 3₁, 3₂, and FIG. 3 is a Master/Slave mode decision flowchart for the copyright protection LSIs 3₁, 3₂.

As shown in FIG. 2 and FIG. 3, at the time of starting up the copyright protection LSIs 3₁, 3₂, by a configuration during an initialization such as exchanging signals between the copyright protection LSIs, determination of Master/Slave modes is performed regarding in which of the Mater mode or Slave mode the processor 9₁ (9₂) of the copyright protection LSI 3₁ (3₂) is to operate (block S31). Subsequently, the processor 9₁ (9₂) reads a mode identifier from the Flash 12₁ (12₂) of the copyright protection LSI 3₁ (3₂) (block S32). Then, when no mode identifier is set (block S33), a mode identifier is written in the Flash 12₁ (12₂) (block S34). The mode identifier is “M” for Master and “S” for Slave for example. When the mode identifier is written in the Flash 12₁ (12₂), the copyright protection LSI 3₁ (3₂) operates in a mode corresponding to the mode identifier (block S35).

At a second or subsequent time of starting up, after the Master/Slave mode is decided by the configuration during the initialization (block S31) similarly to the first time of starting up, the processor 9₁ (9₂) of the copyright protection LSI 3₁ (3₂) reads the mode identifier written in the Flash 12₁ (12₂) at the time of starting up (block S32). At this time, since the mode identifier is set (block S33), a determination result by the configuration and a determination result by the mode identifier are compared (block S36). When a comparison result thereof indicates matching as Master (block S37), the copyright protection LSI 3₁ operates as Master (block S35), and when the comparison result indicates matching as Slave (block S37), the copyright protection LSI 3₂ operates as Slave (block S35). On the other hand, when the comparison result indicates non-matching (block S37), the copyright protection LSI 3₁ (3₂) does not execute recording processing by halting or the like (block S38).

As above, the copyright protection LSI 3₁ is set as Master (primary device), and the key data for decrypting the contents data stored in the HDD 23 is stored in the Flash 12₁ of the copyright protection LSI 3₁. On the other hand, the copyright protection LSI 3₂ is set as Slave (secondary device), and the key data for decrypting the contents data stored in the HDD 23 is not stored in the Flash 12₂ of the copyright protection LSI 3₂.

Then, since the setting as the Master and setting as the Slave are performed at the time of starting up the copyright protection LSIs 3₁, 3₂, components which are identical in a hardware aspect can be used as the copyright protection LSIs 3₁, 3₂.

Further, since setting as Master and setting as Slave are maintained after being performed once (in other words, the setting will not be switched in any circumstances), key data for decrypting contents data stored in the HDD 23 can be managed reliably by the copyright protection LSI 3₁ set as Master.

Next, a case of recording/reproducing contents data in the receiving system Master will be explained.

Contents data scrambled for realizing restricted reception is received by the tuner module 2₁ and demodulated into TS (Transport Stream) packets. The contents data demodulated by the tuner module 2₁ is MULTI2-descrambled by the MULTI2 descrambler 7₁ of the copyright protection LSI 3₁ using key data generated in cooperation with the B-CAS card 5.

In the descrambled contents data, TS packets having a PID specified by the higher application is passed by the PID filter 8₁. Then, using key data generated by the processor 9₁ based on an authentication result between the higher application and the copyright protection LSI 3₁, the contents data is locally encrypted and outputted to the software decoder 4₁ via the PCI bus 14.

The locally encrypted contents data is decrypted by the decryption unit 15₁ of the software decoder 4₁. Then, the decrypted contents data is encrypted by the encryption/decryption unit 19₁ using the key data stored in the Flash 12₁ of the copyright protection LSI 3₁ and recorded in the HDD 23.

When reproducing the contents data recorded in the HDD 23, the contents data is read from the HDD 23, and the read contents data is decrypted by the encryption/decryption unit 19₁ using the key data stored in the Flash 12₁ of the copyright protection LSI 3₁. The decrypted contents data is separated into audio data and video data by the demux 16₁. Then, the audio data is decoded by the audio decoder 17 and outputted to the speaker 21. On the other hand, the video data is decoded by the video decoder 18 and outputted to the LCD 22.

Next, a case of recording/reproducing contents data by the receiving system Slave will be explained.

Scrambled contents data is received by the tuner module 2₂ and demodulated into TS packets. The contents data demodulated by the tuner module 2₂ is MULTI2-descrambled by the MULTI2 descrambler 7₂ of the copyright protection LSI 3₂ using key data generated in cooperation with the B-CAS card 5.

In the descrambled contents data, TS packets having a PID specified by the higher application is passed by the PID filter 8₂. Then, using key data generated by the processor 9₂ based on an authentication result between the higher application and the copyright protection LSI 3₂, the contents data is locally encrypted and outputted to the software decoder 4₂ via the PCI bus 14.

The locally encrypted contents data is decrypted by the decryption unit 15₂ of the software decoder 4₂. Then, the decrypted contents data is encrypted by the encryption/decryption unit 19₂ using the key data stored in the Flash 12₁ of the copyright protection LSI 3₁, not in the Flash 12₂ of the copyright protection LSI 3₂, and recorded in the HDD 23.

When reproducing the contents data recorded in the HDD 23, the contents data is read from the HDD 23, and the read contents data is decrypted by the encryption/decryption unit 19₂ using the key data stored in the Flash 12₁ of the copyright protection LSI 3₁, not in the Flash 12₂ of the copyright protection LSI 3₂. The decrypted contents data is separated into audio data and video data by the demux 16₂. Then, the audio data is decoded by the audio decoder 17 and outputted to the speaker 21. On the other hand, the video data is decoded by the video decoder 18 and outputted to the LCD 22.

As described above, in the information processing apparatus 1, key data for decrypting contents data stored in the HDD 23 is stored in the Flash 12, of the copyright protection LSI 3₁ set as Master. Accordingly, when contents data encrypted and stored in the HDD 23 is copied to a storage device of another information processing apparatus, and a tuner card in which the tuner module 2₁ and the copyright protection LSI 3₁ are constructed is fitted in the another information processing apparatus, it is not possible to decrypt the encrypted and stored contents data simultaneously in the information processing apparatus 1 and in the another information processing apparatus. Further, when the contents data encrypted and stored in the HDD 23 is copied to a storage device of another information processing apparatus, and the tuner card in which the tuner module 2₂ and the copyright protection LSI 3₂ are constructed is fitted in the another information processing apparatus, it is not possible to decrypt the encrypted and stored contents data in the another information processing apparatus. Therefore, according to the information processing apparatus 1, unauthorized copying of encrypted and stored contents data can be prevented.

The present invention is not limited to the above-described embodiments. For example, two or more receiving systems Slave may be provided for one receiving system Master.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a plurality of data encryption devices obtaining and encrypting contents data;
a plurality of data decryption devices provided corresponding to said data encryption devices respectively, each of said data decryption devices obtaining the contents data via a user access bus from corresponding one of said data encryption devices and decrypting the contents data; and
a data storage device storing the contents data encrypted by said data decryption devices, wherein
key data for decrypting the contents data stored in said data storage device is stored in one of said data encryption devices.

2. The information processing apparatus according to claim 1, wherein each of said data decryption devices obtains the key data from the one of said data encryption devices storing the key data and decrypts the contents data stored in said data storage device.

3. The information processing apparatus according to claim 1, wherein the one of said data encryption devices storing the key data is set as a primary device, and another one of said data encryption devices is set as a secondary device.

4. The information processing apparatus according to claim 3, wherein the setting as the main device and the setting as the secondary device are performed when said data encryption devices are started up.

5. The information processing apparatus according to claim 3, wherein the setting as the main device and the setting as the secondary device are maintained after being performed once.
